(19) United States
(12) Patent Application Publication
(10) Pub. No.: US 2008/0172294 A1
(43) Pub. Date: Jul. 17, 2008

(54) Online modified dutch auction

(76) Inventors: Mark J. McGuire, Waunakee, WI (US); Brian T. Wiegand, Waunakee, WI (US)

Correspondence Address: BRINKS HOFER GILSON & LIONE, P.O. BOX 10395, CHICAGO, IL, 60610, US

(21) Appl. No.: 11/652,845

(22) Filed: Jan. 12, 2007

(51) Int. Cl. G06Q 30/00

(52) U.S. Cl. 705/14; 705/37

(57) ABSTRACT

A system and method are provided for selling products in a modified Dutch auction format. A limited quantity of a designated product is offered for sale. The products are offered at an initial price, which is then discounted over time. Buyers may choose to purchase a product at any time after the modified Dutch commences, but buyers will receive a better final price the longer they wait to make a purchase; however, buyers must make a purchase before the last product is sold, or they will miss out on the deal entirely. A modified Dutch auction may be implemented in an online environment.

### BACKGROUND

1. Technical Field

The present invention relates to online auctions. Specifically, the invention relates to systems and methods for conducting a modified Dutch auction over a computer network.

2. Related Art

Auctions are efficient mechanisms for selling just about anything, from fine art and real estate to automobiles, antiques, and consumer products. Auctions may be employed to determine the highest price a buyer is willing to pay for a particular item, whatever that item happens to be. Furthermore, auctions can be exciting events that generate a great deal of interest in the items being sold. Sometimes, in the heat of the moment, auction participants may be induced to bid higher for an item than they might otherwise be willing to pay under other circumstances. Thus, traditional auctions are typically effective for maximizing the sale price of the item being sold.

Auctions may be conducted in many different formats. In a traditional auction, a plurality of buyers bid against one another to buy an item from a single seller. In a reverse auction the numbers are reversed. Many sellers compete with one another to sell a particular item to a single buyer. A reverse auction determines the lowest price at which a seller is willing to sell a particular item. As one would expect, a reverse auction tends to lower the price. A Dutch auction is similar to a traditional auction in that a plurality of buyers compete to buy from a single seller. However, whereas in a traditional auction the price starts low and auction participants bid the price higher, in a Dutch auction the price starts high (generally significantly higher than auction participants are willing to pay) and is steadily lowered until it reaches a price that an auction participant is willing to pay. Thus, a Dutch auction ends when the first bid is received. A Dutch auction can become a battle of nerves, as auction participants wait for the price to come down in order to receive the lowest possible price, while simultaneously trying to ensure that they make the first (and therefore the winning) bid.

The Internet has proven to be an effective medium for conducting auctions. In fact, a Website devoted almost exclusively to auctioning new and used products is currently one of the more popular Websites on the Internet. With typical Internet auctions, the bidding will be open for a predetermined length of time. Potential buyers may access the website via their Internet browsers and may place bids on the various items being auctioned. At the close of bidding the party who placed the highest bid wins the item at the bid price. The sale is considered final at the close of bidding. In fact, bidders may have established accounts which are automatically charged when they have a winning bid at the close of bidding.

Interest is low for many online auctions. Often there are very few bids on an item until very close to the end of the bidding period. Potential buyers must place their bids and then wait to see if someone places a higher bid. In many cases this may go on for several hours. Meanwhile, there may be little or no action in the auction. Waiting to see if your bid is accepted can be very tedious indeed. Therefore it is desirable to develop a new, more exciting online auction format that is more engaging for participants. A more exciting auction format will likely draw more participants and will likely increase the success of the auction. A more exciting auction format may also increase goodwill toward the party conducting the auction, which may spill over into other selling opportunities.

### BRIEF SUMMARY

The present invention relates to methods and systems for selling products in a modified Dutch auction format. According to an embodiment of the invention a limited quantity of a designated product is offered for sale. The number of products being offered may be withheld from the participants in the modified Dutch auction. The number of products may range from one to many depending on the discretion of the party conducting the modified Dutch auction. The products are offered at an initial price which is then discounted over time. According to an embodiment, the discount is provided in the form of cash back savings that are reimbursed to the purchaser at some time after the modified Dutch auction is over. An auction participant who purchases a product during the modified Dutch auction initially pays the full in-store price, then receives a discount in the form of a cash back payment. Buyers may choose to purchase a product any time after the modified Dutch auction commences. Since the price is discounted over time, the buyer will receive a better final price the longer he or she waits to make a purchase. However, because the participants in the auction are unaware of the number of products being sold, the potential buyers cannot be certain when the last product will sell. The modified Dutch auction becomes both a waiting game to see how low the price will go and a guessing game to determine the best time to buy in order to obtain the best possible deal before all of the products are sold. Thus, rather than bidding prices higher, buyers vie with one another to obtain the lowest possible price before the products sell out.

According to an embodiment, a method of conducting an online modified Dutch auction includes designating a quantity of a particular product to be sold during the auction. Once the product has been designated, an initial price must be established for the individual products being sold. The initial price of the product is then discounted over time. Orders for individual products are accepted from auction participants. The orders include a price determined by the initial price of the product and a current discount. The current discount is calculated based on the rate at which the initial price is discounted over time and the time at which the order is accepted.

According to another embodiment, a system for conducting an online modified Dutch auction is provided. The system includes a Web server for receiving URL requests from clients over a computer network such as the Internet. The Web server sends auction interface pages to the clients in response to the URL requests. The auction interface pages are adapted to be displayed by browser applications running on the clients. The Web server includes at least one application server for generating dynamic content to be displayed on the auction interface pages. Finally, a database stores data for populating data fields on the auction interface page.

In yet another embodiment, a computer readable storage medium is provided. The computer readable storage medium contains software instructions executable by a computer. The software instructions are configured to cause a computer to perform the steps of displaying a current discount associated with a modified Dutch auction. The software instructions are further configured to provide a selectable input that allows a user to place an order for a product being sold in the modified Dutch auction at a price determined by the current discount.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

FIG. 1 is a flowchart showing a method of conducting a modified Dutch auction according to an embodiment of the invention.

FIG. 2 is an image of a modified Dutch auction GUI Web page at the start of the modified Dutch auction.

FIG. 3 is an image of a modified Dutch auction GUI Web page at an intermediate point of time after the modified Dutch auction has started, but before the modified Dutch auction is over.

FIG. 4 is an image of a GUI Web page that may be displayed at the conclusion of the modified Dutch auction.

FIG. 5 is a block diagram of a system for implementing an online modified Dutch auction.

### DETAILED DESCRIPTION

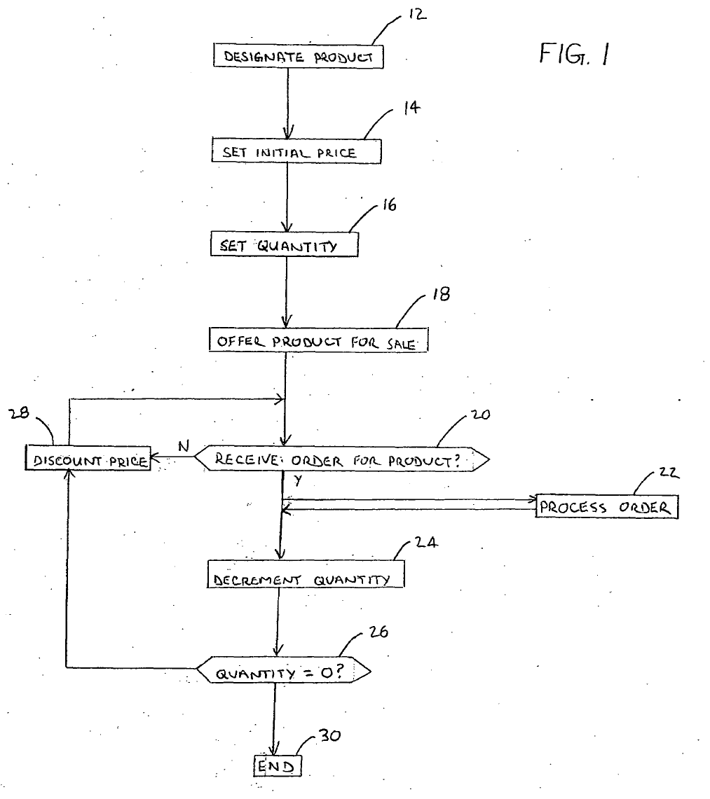

FIG. 1 is a flow chart showing a method for offering a quantity of a designated product for sale in a modified Dutch auction format according to an embodiment of the invention. First, the product is designated at 12. Substantially any product may be sold in the modified Dutch auction format according to the present disclosure. For practical reasons, however, it may be desirable to only designate popular items that are in high demand in order to attract attention to and generate interest in the modified Dutch auction. In one embodiment, a community of users may recommend or even select the products to be auctioned. For example, a group of auction participants who have previously purchased products though similar auctions, or the best customers of the party conducting the modified Dutch auction may be assembled to vote on and select the products to be sold at upcoming modified Dutch auctions. This may take place on-line in a chat room with a live administrator, or over any other interactive medium where many users may participate and make known their preferences.

Once a product has been designated, the initial selling price is set at 14. Again, the initial price may be set at substantially any value, however, practical considerations may favor an initial selling price comparable to or even below the price at which buyers could purchase the item at other retail outlets. Another consideration is that a product should be selected having a large enough value that buyers will be interested in following the modified Dutch auction to see how low the price may be discounted before the product sells out. Interest in the modified Dutch auction will be greater if buyers see the potential for significant savings.

Next, the quantity of items to be sold is set at 16. Again, any number products may be offered for sale during the course of the modified Dutch auction. However, the practical consideration here is that the quantity should not be so large that a lack of sufficient demand drives the final selling price below a level desired by the party conducting the modified Dutch auction.

Once the product has been selected, the initial price established, and the quantity set, the modified Dutch auction may begin. The designated product is offered for sale at 18. Orders may or may not be received at 20. If an order is not received at 20, the price is discounted at 28, and the process returns to 20. Again, if an order is not received at 20 the price is discounted at 28, and the process continues until an order is actually received. The rate at which the price is discounted at 28 may be calculated in a number of different ways. For example, the modified Dutch auction may be set up to run for a finite length of time during which the initial price is discounted from 0% at the beginning of the sale to 100% at the end of the designated time period. The discount rate may be linear or according to any other formula. Alternatively, the price may be discounted by a specified amount per unit time, such as by 1% per minute, $5 per minute, or any other value during any designated period of time. These are but a few examples of different discount algorithms that may be employed in a modified Dutch auction according to the present embodiment. Any other scheme for discounting the price over time may be employed without deviating from the scope of the present disclosure.

When an order is received at 20, the quantity of products available is decremented at 24. After the quantity is decremented, the quantity available is compared to 0 at 26. If the quantity available remains greater than 0, there are still products remaining to be sold, and the modified Dutch auction continues. The price is again discounted at 28 and continues to be discounted until another order is received at 20. If the quantity equals 0 at 26, it means that the last available product has been sold, and the modified Dutch auction is over.

In a variant to the method illustrated in FIG. 1, participants may be allowed to enter proxy orders. For example, an auction participant may wish to purchase a product being sold in a modified Dutch auction if the discount reaches 40%. The user may enter a proxy order for the product contingent on the discount reaching 40%. During the course of the modified Dutch auction, if products remain unsold when the discount reaches 40%, the proxy order may be executed automatically, and the purchaser may obtain the product at the designated discount. In this way users may be allowed to participate in modified Dutch auctions without having to monitor the activity in real time.

In another variant, the modified Dutch auction may be structured more as a silent auction. Again, one or more products may be offered. Bidding may be left open for an extended period of time, such as over a 24 hour period or over a weekend, or over some other time period. Participants may submit conditional offers to purchase a product at a specified cash back value. At the close of bidding, the best cash back offer or offers will be accepted, for example, by accepting the highest unique offer. This allows the excitement of the auction to be extended for a longer time, and allows people to participate “around the-clock” in case they are unavailable for regularly scheduled modified Dutch auctions.

A final variant is to offer a separate game alongside the modified Dutch auction in order to increase the excitement surrounding the event. Participants may be allowed to enter guesses as to what the final cash back savings discount will be on the last product sold during a modified Dutch auction. The person with the guess closest to the final discount may win a prize. Prizes may range from a free product, additional cash back savings on the winner's next purchase, a free spin of a virtual fortune wheel holding multiple different potential prizes, or some other prize. These features may add a carnival or game show atmosphere to the modified Dutch auctions to further increase interest and draw additional participants and can be used as a transition between one modified auction to another.

According to an embodiment of a modified Dutch auction, a purchaser may actually purchase the item from a third party merchant. The purchaser may pay the third party merchant the full in-store price for the product and receive the discount in the form of cash back savings from the party conducting the modified Dutch auction. The party conducting the modified Dutch auction may hold onto the cash back savings for a period of time until the sale becomes final, such as at the expiration of a period during which returns are permitted, to ensure that the product is not returned or exchanged. The merchant offering the product for sale may pay a cost-per-sale advertising fee to the party conducting the auction for each product sold. The cost-per-sale advertising fee may be used to fund the cash back savings to be paid to the purchaser. An advantage of this “cash back” model is that it forms a stronger tie between the purchaser and the party conducting the modified Dutch auction. The purchaser's cash back savings may be deposited into a purchaser's online account. The purchaser's may have to return to the online auction site to access his or her cash back savings. During the course of such a return visit the purchaser may be enticed to participate in other auctions or to buy other products directly. Thus, the cash back discounting model forms a “stickier” relationship with the purchaser likely to result in additional contacts with the purchaser that may lead to additional sales. Another advantage is that the party conducting the modified Dutch auction may receive a cost per sale advertising fee from the merchant shortly after the sale while not being obligated to pay the cash back savings for some longer period of time. Thus, the party conducting the modified Dutch auction may take advantage of the cash during this period in which the purchaser does not request his or her cash back.

Merchants will like such as arrangement as well, especially if the cash back savings exceed the cost per sale advertising fee the merchant agrees to pay. In this case, the party conducting the modified Dutch auction is in effect subsidizing the merchant's advertising costs, using its own advertising to grow and engage its own user base while at the same time growing sales for its merchant partners. In other words, when the cash back discount is greater than the cost per sale advertising fee, the merchant is gaining additional sales and pricing promotion without having additional advertising fees or other out of pocket costs. Furthermore, the modified Dutch auction allows the merchant to sell discounted products while protecting established price points in other markets.

The modified Dutch auctions may be based on several different business models. For example, the party conducting the modified Dutch auctions may receive cost per sale advertising fees from merchants to fund the auction cash back payments. The party conducting the modified Dutch auctions may also fund the cash back savings paid to purchasers itself, making up any deficit caused by a difference between the purchaser's cash back amount provided and the amount the party conducting the auction receives in cost per sale advertising or other fees associated with the auction sale. In this case the party conducting the auction may actually loose money on each transaction. However, the modified Dutch auctions may be employed as a loss leader for driving more traffic to the party's online auction site, engaging and entertaining its customer base, building its brand, driving additional sales, attracting additional merchant partners, and the like. In order to minimize losses, the party conducting the modified Dutch auction may reduce the quantity of products offered if the cash back amount exceeds a predetermined amount. For example, assume the party conducting the modified Dutch auction will begin loosing money if the cash back savings exceed 25%. Suppose it originally intends to sell 10 products during the course of an auction. Suppose further that at a cash back savings of 24% only two products have been sold. As the price drops further, the party conducting the auction will loose money on each additional sale. Therefore the party conducting the modified Dutch auction may adjust the number of products to be sold to 3 such that the next sale will end the auction, limiting the party's losses on additional sales. In addition to receiving cost per sale advertising fees for sales, the party conducting the auction may employ other means of funding the auction and the cash back payments. For example, the party conducting the modified Dutch auctions may partner with manufacturers, retailers or any other advertiser who agrees to sponsor auctions by providing discounted goods, sponsorship fees, or the like. Publicity associated with the modified Dutch auctions may create a positive buzz surrounding new products that may lead to additional sales. If the cost per sale advertising fee arrangement described above is employed, the merchants or manufacturers providing the products are simply paying a known amount to buy completed sales, a particularly targeted and productive use of their advertising dollars.

The method of offering a quantity of a designated product for sale in a modified Dutch auction described above may be implemented in an online environment in which a central Web server (or servers) controls the modified Dutch auction. Auction participants may interact with the central Web server over the Internet using a Web browser running on a Web enabled personal computer or other Web enabled device. The Web server may provide one or more Web pages that may be displayed by the buyers' Web browsers. The displayed Web page or Web pages may provide a graphical user interface (GUI) allowing the auction participants to interact with the Web server and participate in the modified Dutch auction.

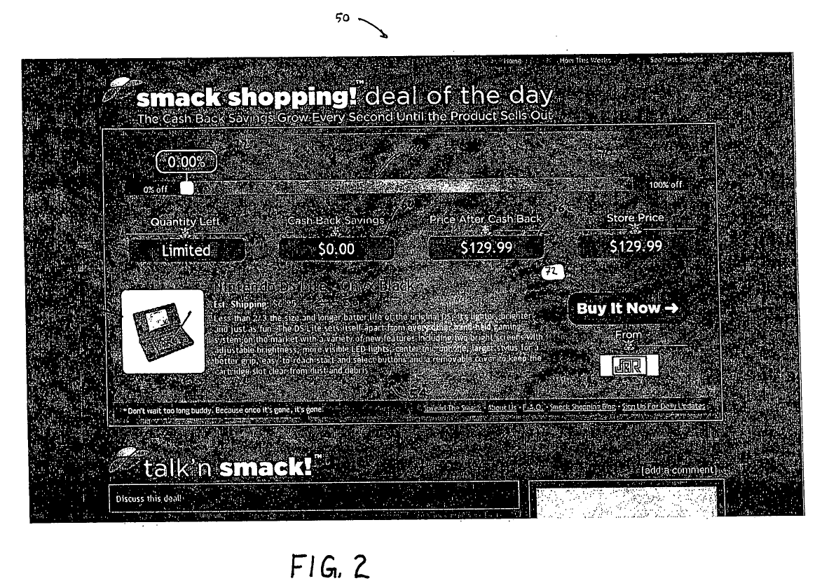

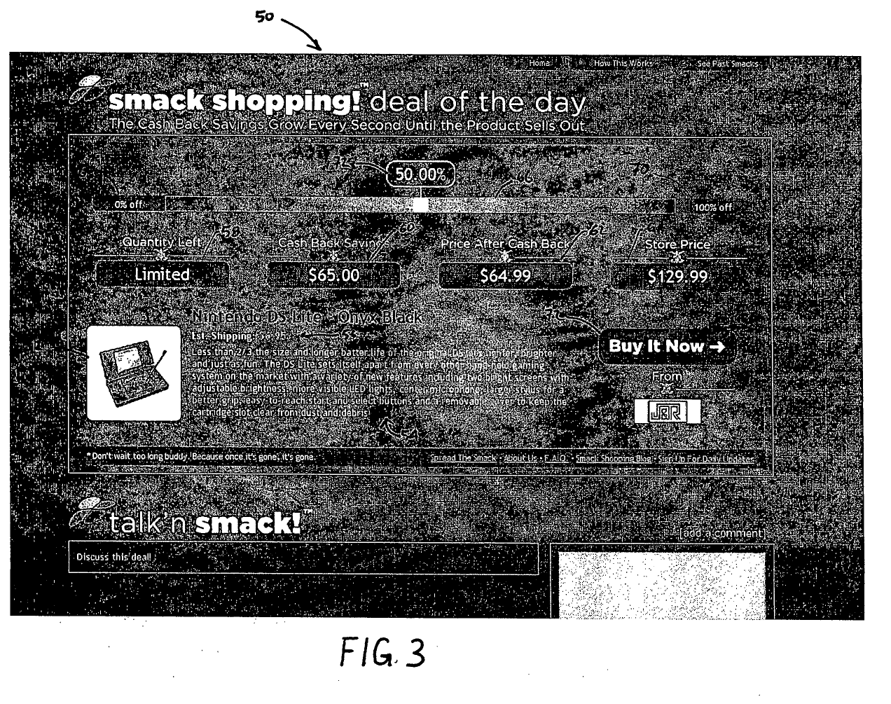

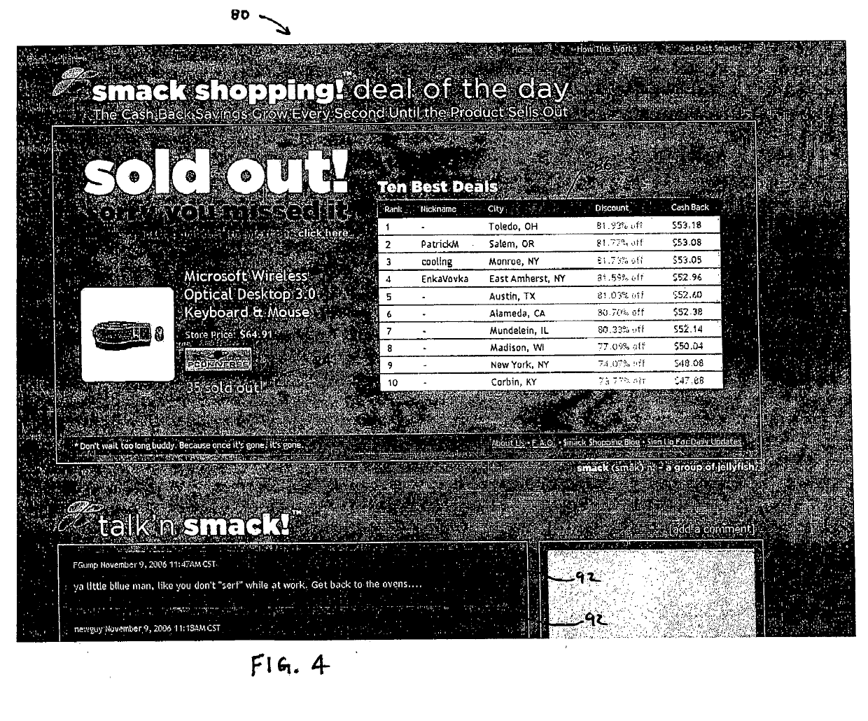

FIGS. 2 and 3 show a sample Web page 50 displayed by a buyer's Web browser and providing a GUI for allowing buyers to participate in an online modified Dutch auction. FIGS. 2 and 3 show the web page 50 at two distinct times during the course of an online modified Dutch auction. FIG. 2 shows the Web page 50 as the online modified Dutch auction commences. FIG. 3 shows the Web page 50 at some intermediary point after the online modified Dutch auction has started, but before the last product has been sold. FIG. 4 shows a Web page 80 that may be displayed after the last product has been sold and the modified Dutch auction has ended.

Turning first to FIG. 2, the Web page 50 shows a picture of the product 52 offered during the online modified Dutch auction and a written description 54 of the product. Various display fields provide information regarding the progress of the modified Dutch auction. A “Quantity Left” field 58 may display the number of items remaining in the modified Dutch auction. A “Cash Back Savings” field 60 displays the amount of money a buyer will save by purchasing a product at any point during the course of the modified Dutch auction. A “Price After Cash Back” field 62 displays the total price a buyer will pay after receiving the cash back savings if the buyer purchases the product at a particular point in the modified Dutch auction. A “Store Price” field displays the typical retail price of the product, which may also coincide with the initial offering price of the product at the start of the modified Dutch auction. A real-time ticker 66 displays the progress of the modified Dutch auction. A “Buy It Now” button 72 takes the buyer to an order processing page where the buyer may place an order for the item at the amount of cash back savings current at the time the order is processed.

The real-time ticker 66 essentially displays a discount scale extending from 0% savings on the left end 68 of the ticker 66 to 100% savings on the right end 70 of the ticker 66. A sliding window 72 moves along the real-time ticker 66 as the modified Dutch auction progresses. The modified Dutch auction begins with the sliding window 72 at the extreme left end 68 of the ticker 66 as shown in FIG. 2. In this position, the sliding window holds the value 0.00%. This indicates that if a buyer were to purchase the product at the very start of the modified Dutch auction, he or she will receive 0.00% cash back savings. In other words, a buyer who places an order at the very outset of the modified Dutch auction will pay full price for the product. During the course of the modified Dutch auction, however, the sliding window 72 moves to the right, indicating increased cash back savings over time. As long as there are products remaining, the cash back savings continue to grow. In fact, if the products do not sell out before the scheduled end of the auction, the cash back savings will eventually reach 100%, at which time the products could theoretically be claimed for free. However, because the products will typically be high demand items, buyers will not want to miss out on receiving a good bargain and will buy the products as soon as they reach a price that is too good for the buyers to pass up. Since the products are to be sold in limited quantities, it may be expected that the products will sell out long before the cash back savings reach 100%.

In the example shown in FIG. 2, a hand-held gaming system is being offered for sale. A picture 52 of the gaming system is shown, and a written description 54 of the product is also provided. An estimated shipping cost 56 for shipping the product to the buyer is also shown. At the start of the modified Dutch auction, the total number of products being offered will equal the number of products left. As illustrated in FIG. 2, the party conducting the modified Dutch auction may choose not to display the number of products being offered. This uncertainty may encourage buyers to make their purchases earlier in the modified Dutch auction to avoid missing out on the cash back savings in the event that all of the products are sold before the buyer decides to make a move to purchase the product. As mentioned, the sliding window 72 begins at the left end 68 of the real-time ticker 66, indicating 0% cash back savings at the start of the modified Dutch auction. Correspondingly, the Cash Back Savings field 60 displays $0.00 cash back savings at the start of the modified Dutch auction. With $0.00 cash back savings, the Price After Cash Back field 62 displays the value $129.99, which is equal to the value displayed in the Store Price field 64.

FIG. 3 shows the same GUI Web page 50 for the same modified Dutch auction shown in FIG. 2, but after a significant amount of time has passed. The sliding window 72 of the real-time ticker 66 has moved halfway between 0% cash back savings 68 and 100% cash back savings 70, indicating 50% cash back savings for a buyer who purchases the item at the time represented in FIG. 3. The components of the GUI Web page 50 shown in FIG. 3 are the same as those of the GUI Web page 50 shown in FIG. 2, except that the values in the various fields have changed to reflect the changing circumstances of the modified Dutch auction as time moves forward. The Cash Back Savings field 60 displays a value of $65.00, resulting in a Price After Cash Back 62 value of $64.99. Again, a buyer may purchase a product at any time by selecting the “Buy It Now” button 72 and completing the corresponding order form as long as products remain. Once the last product is sold, however, the modified Dutch auction is over, and buyers who failed to complete orders during the course of the modified Dutch auction have missed out on all of the cash back savings that may have accrued during the course of the modified Dutch auction.

FIG. 4 shows a GUI Web page 80 that is displayed after the last available product has been sold. The real-time ticker 66, and the various fields displaying the Quantity Remaining 58, the Cash Back Savings 60, the Price After Cash Back 62 displayed on the GUI Web page 50, have been replaced by a “Sold Out” banner 82 and a table 86 listing the ten best deals received by various buyers who bought the product during the course of the modified Dutch auction. Like the earlier GUI Web page 50, the GUI Web page 80 includes a picture of the product 52 and a written description 54. After all of the products have been sold, the GUI Web page 80 may display the total number of items sold during the course of the modified Dutch auction.

In order to enhance the excitement and social nature of the modified Dutch auction, the GUI Web pages 50, 80 may include a real-time chat component whereby potential buyers participating in an online modified Dutch auction may post comments to one another and read the posts of other potential buyers. This added layer of communication between the modified Dutch auction participants allows potential buyers to comment on the product and to voice opinions as to what price would constitute a good deal. The real-time chat also provides potential buyers the opportunity to collude with one another to wait for the lowest price, as well as the opportunity to betray one another by buying earlier at a higher price than previously agreed upon, thereby obtaining the best deal possible at the expense of the other potential buyers. The chat feature enhances the online shopping experience, creating a fun and social atmosphere. The GUI Web page 50 displaying an ongoing modified Dutch auction may include a real-time chat window 90 for displaying the comments 92 offered by the participants in the modified Dutch auction, as well as an Add Comments window 94 allowing a modified Dutch auction participant to enter his or her own comments.

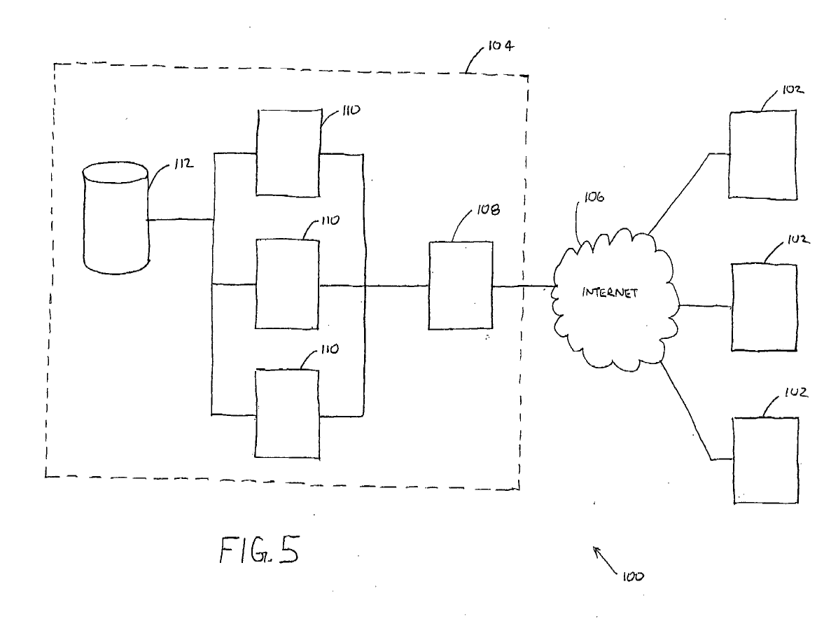

FIG. 5 is a block diagram of a system 100 for conducting an online modified Dutch auction. A plurality of clients 102 communicate with a Web server 104 over a public network 106 such as the Internet. The clients 102 are simply Internet-enabled computers running a Web browser application that allows auction participants to access the World Wide Web and participate in the modified Dutch auctions managed and controlled by the Web server 104. The Web server 104 includes a front-end proxy server 108 for responding to URL requests from Web clients 102 and serving Web pages and content to the various clients 102. The proxy server 108 performs typical Web server functions, such as providing security functions, filtering, buffering, and load distribution among the back-end application servers 110. The proxy server 108 may be an Apache Web server, an open source Web server commonly used for World Wide Web applications. The Web server 104 further includes one or more back-end application servers 110 and a database server or servers 112. The proxy server 108 pulls content from the application servers 110 in response to requests from the clients 102. The application servers 100 in turn pull data from the database server or servers 112 to populated Web pages with dynamic content representing the progress of an online modified Dutch auction. The proxy server 108 routes the Web pages to the various clients 102 in response to URL requests from the clients 102.

Participants in the online modified Dutch auction access the online modified Dutch auction by entering a URL request in the Web browser of a client computer 102. The URL request identifies the Web server 104 and requests the GUI Web page from the proxy server 108. Upon receiving an initial URL request, the proxy server 108 sends the basic components of the Web page comprising a modified Dutch auction GUI to the client 102. This initial page may include static content that will be displayed by the client's Web browser throughout the modified Dutch auction and will not change so long as the client remains connected. Such static content may include a banner announcing the modified Dutch auction, a corporate logo of the party sponsoring the modified Dutch auction, advertisements, and other interface components that will frame the dynamic content that will be displayed on the GUI Web page over the course of the modified Dutch auction.

Also embedded in the initial page sent to the clients 102 are requests for additional components of the modified Dutch auction GUI that may be executed by a client's Web browser. One such request is for a JavaScript that sets up the modified Dutch auction for display by the client's Web browser. This “Auction Set-up” script is a program that runs on the client 102 and causes much of the dynamic content corresponding to an ongoing modified Dutch auction to be displayed by the client's Web browser. The Auction Set-up script includes all of the instructions for creating the real-time ticker 66 and for creating the “Quantity Left”; “Cash Back Savings”; “Price After Cash Back”; and “In Store Price” fields of the GUI Web page 50 (see FIGS. 2 and 3). Additional requests from the clients 102 cause the application servers 110 to pull data from the database server or servers 112 in order to populate the various fields created by the Auction Set-up script with specific data related to the modified Dutch auction at hand.

With regard to the real-time ticker 66, according to an embodiment of the GUI Web page, the position of the sliding window 72 and the amount of cash back savings are calculated by the client 102 based on the timing of the client's internal clock and the initial conditions of the modified Dutch auction. The initial conditions may include the in-store price of the product being auctioned, the auction start time, the length of time the auction will be active, the initial discount or cash back savings (if any), the planned maximum duration of the modified Dutch auction, and the current time. With this information, the software instructions included in the Auction Set-up script can calculate the rate at which the discount or cash back savings are to grow over the course of the modified Dutch auction. Based on the initial price of the product, the auction start time, the current time, and the discount growth rate, the Auction Set-up script can use the client's internal clock as a counter to calculate the present discount, the cash back savings, and the price after cash back at any given time during the course of the modified Dutch auction.

As an example, assume that the modified Dutch auction is set to last for a maximum of 1 hour. Assume also that the modified Dutch auction is to begin with no initial discount. In this case, the discount must grow from 0% savings to 100% savings over the course of 60 minutes. Assuming that the discount will grow at a linear rate, the discount will grow at a rate of 1.667% per minute, or approximately 0.028% per second. Assume that the data provided with the Auction Set-up script indicate that the modified Dutch auction was to begin at 12:00 noon and that the current time is 12:37:35. Assume further that the initial price of the product was set at $199.99. At the time 12:37:35, the auction has been in progress for 37 minutes 35 seconds, or a total of 2,555 seconds. At a discount rate of 0.028% per second, this corresponds to a current discount of 63.14%.

With a current discount of 63.14%, the client Web browser displays the real-time ticker 66 with the sliding window 72 nearly two-thirds across the length of the ticker 66, and with the value 63.14% displayed within the sliding window 72. The Cash Back Savings may be calculated based on the current discount and the initial in-store price, 63.14% and $199.99, respectively. In this case, the current cash back savings would equal $126.27, and the price after cash back would equal $73.72. These values are all calculated on the client side of the client/server arrangement. This is significant in that the position of the sliding window 72 along the real-time ticker 66 allows the current discount value to be displayed within the sliding window 72, and the Cash Back Savings 60 and the Price After Cash Back 62 may all be updated and displayed by the event 102 Web browser in essentially real-time, but based on the client's internal clock and without constant reference back to the Web server 104 across the network 106.

The Auction Set-up script may include provisions for maintaining synchronization with in the Web server 104 in order to avoid drift between the Web server's internal clock and the client's internal clock. Such provisions may include instructions for causing the client's Web browser to periodically send a re-synchronization request back to the Web server 104. The Web server 104 may respond to such a request by sending a current time value based on the Web server's internal clock back to the client 102. Upon receiving the current time from the web server 104, the client 102 Web browser may re-synchronize its calculations accordingly.

A periodic re-synchronization request may also be used to receive additional information from the Web server, which may change over time, but which cannot be calculated on the client side. For example, as mentioned above, the GUI Web page displayed by the client's Web browser may contain a chat area 90 in which modified Dutch auction participants may post comments and read the comments of others. A participant may enter a comment by typing the comment into the “Add A Comment” area 94 of the GUI Web and selecting a transmit or send input that may also be provided on the GUI web page. The client Web browser sends a message to the Web server 104 that includes the purchaser's comment. The proxy server 108 forwards the message to an available application server 110. The application server 110 recognizes the message as a chat comment and stores the message in an appropriate location in the database server or servers 112. A periodic re-synchronization request sent from a client to the web server 104 may include a request to update the chat messages displayed in the client's chat area 90. The periodic re-synchronization request for updating chat messages may be the same re-synchronization request as that for maintaining clock synchronization, or it may be sent as a separate request. The request may include an identifier identifying the last chat message received by the client 102 sending the update request. Again, the proxy server 108 forwards the update request to an available application server 10. The application server 110 accesses the database server or servers 112 to determine whether there have been any additional chat messages posted after the last chat message was sent to the client. If so, the application server pulls the new messages from the database server or servers 112 and prepares an update message to be sent by the proxy server 108 to the client 102. Upon receiving the update message, the client's Web browser may display the newly received chat messages in the chat display area 92 of the GUI Web page.

In most traditional auctions, the party conducting the auction is not necessarily the party selling the items being auctioned. The same may be the case with the online modified Dutch auctions of the present disclosure. The party conducting the auction may act as an intermediary between the purchasers and a retailer who is actually offering the products for sale. As described above, the GUI web page 50 displayed by a client's Web browser may include a “Buy-it-Now” software button that will allow a modified Dutch auction participant to buy the item being sold at the discount value current at the time. Clicking the Buy-it-Now button causes the client's 102 browser to request an order form from the Web server 104. The order form is displayed by the client browser, and the auction participant purchasing the product may enter information into the form necessary to complete the transaction. Alternatively, the user's information may be stored in advance so that need only select the “Buy it Now” button to execute a transaction. The information required of the purchaser may include name, address, phone number, payment method, credit-card number, expiration date, and the like. The purchaser sends the data back to the Web server 104 by selecting a “Complete Transaction” button, a “Submit Order Button,” or some other input associated with the online order form. The final act of submitting the order locks in the current discount and cash back savings and completes the sale. Because the sale is not final until the order is submitted, the order must be submitted before the last item is sold in order to constitute a valid sale.

Once orders are submitted to the Web server 104, the orders must be processed to ensure that the retailer is paid and that the purchaser receives both the product and the requisite cash back savings. All of the information necessary to process the order may be found in the online order form submitted by the purchaser. In order to fulfill the order, the order must be entered into the retailer's order entry system. This may be accomplished in many different ways depending on the level of sophistication of the interface between the party conducting a modified Dutch auction and the retailer's system. The process may be highly automated, or in fact it may be completely manual.

If the retailer has an online sales presence, any easy—albeit perhaps inelegant solution—is to simply invoke the retailer's online purchasing process. This may be done manually or automatically. In a manual operation, an operator may simply re-enter the purchaser's data from the online order form associated with the modified Dutch auction into the retailer's purchase order Web page. In effect, the party conducting the modified Dutch auction purchases the product from the retailer on behalf of the purchaser. At this point, the purchaser pays the full in-store price, then receives the cash back savings from the party conducting a modified Dutch auction. The manual order entry process has the disadvantage of being very labor-intensive and slow. However, it is relatively easy to set up and requires little if any investment in infrastructure.

A somewhat more sophisticated process might automatically map the information from the online order entry form to the data fields of the retailer's purchase order Web page. In the long run, this method may prove less labor-intensive, but it initially requires significantly more effort to set up the process. Furthermore, the efforts to create such a system must be repeated every time a new retailer is involved with a modified Dutch auction. Other similar solutions might be to automatically generate e-mail orders that may be sent to the retailer, and the like.

Still more elaborate and more efficient processes may also be implemented to communicate orders from the party conducting the modified Dutch auction to the retailer. Such systems may require a higher level of integration between the Web server 104 and the retailer's order entry system. For example, the Web server 104 or database server 112 may accumulate all of the product orders received during the course of a modified Dutch auction and may submit them all to a retailer as a single batch file. Upon receiving the batch file, the retailer's system may extract the order data from the batch file and process the orders individually. A system such as this, while generally more efficient than the methods described above, has the significant drawback that it requires system changes on both ends of the communication between the party conducting the modified Dutch auction and the retailer's order entry system. Persuading retailers to add such functionality may on occasion prove difficult.

A further level of sophistication may be to directly integrate the order processing form generated by the Web server 104 with a retailer's order processing systems. An API running on an Application server may be adapted to transfer the purchaser's data directly to the retailer's system substantially in real-time. The purchaser deals only with the party conducting the modified Dutch auction, yet the order is processed immediately by the retailer. The retailer may charge the purchaser's credit-card account and ship the product to the customer, however all other communications with the purchaser may come from the party conducting the modified Dutch auction. Integrating the order data with the retailer's order processing system has the advantages of speed, efficiency, and seamless operation. However, it requires much greater cooperation and effort between the party conducting a modified Dutch auction and retailer.

With the systems described above, a party may conduct a live, online modified Dutch auction to sell various products. The excitement generated by such an event may draw positive attention to the party conducting the modified Dutch auction and may have a spillover effect toward other online sales efforts. Furthermore, the cash back savings that purchasers receive from purchases made in the reverse-type auctions may be paid into an online account controlled by the party conducting the online modified Dutch auction. The account may be established with certain restrictions for withdrawing funds, such as encouraging purchasers with money in their accounts to purchase additional items from the party conducting the modified Dutch auction. Such an arrangement is likely to generate additional sales, and ensures additional contacts and revenue generating opportunities with each purchaser.

In yet another arrangement, the party conducting the modified Dutch auction may store all of a purchaser's payment information. Upon receiving an order, the party conducting the auction may purchase the product directly from the retailer. The party conducting the auction may then bill purchaser, in this method the purchaser is shielded from any real interaction with the retailer.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method of conducting an auction comprising:
designating a quantity of a particular product to be sold during the auction;
establishing an initial price for individual products within the quantity of the particular product to be sold;
discounting the price over time;
accepting orders for individual products, the orders including a price determined by the initial price and a current discount calculated based on a discount rate at which the initial price is discounted over time and the time at which the order is accepted.

2. The method of conducting an auction of claim 1 wherein the current discount is calculated using a discount algorithm which causes the current discount to grow from 0% to 100% over a designated time period.

3. The method of conducting an auction of claim 2 wherein the discount algorithm is linear from 0% to 100% over the designated time period.

4. The method of conducting an auction of claim 1 wherein discounting the price over time comprises establishing a cash back amount to be paid to a purchaser who purchases a product during the auction.

5. The method of conducting an auction of claim 4 wherein the cash back amount is calculated based on the current discount.

6. The method of conducting an auction of claim 5 wherein the cash back amount is calculated by multiplying the initial price by the current discount.

7. The method of conducting an auction of claim 1 further comprising graphically displaying the progress of the auction by displaying a current discount value.

8. The method of conducting an auction of claim 7 wherein displaying the progress of the auction comprises a real-time ticker that graphically illustrates the growth of the current discount over time.

9. The method of claim 8 wherein the real-time ticker comprises a discount scale extending from a first value to a second value, and a sliding window adapted to move along the discount scale according to the current discount.

10. A system for conducting an online modified Dutch auction comprising:
a Web server for receiving a URL request from a client over a network and sending an auction interface page to the client in response to the request, the auction interface page adapted to be displayed by a browser application running on the client;
an application server for generating dynamic content to be displayed on the auction interface page; and
a database for storing data for populating data fields on the auction interface page.

11. The system of claim 10 further comprising a software script embedded within the auction interface page configured to be executed by the client browser application, for displaying the modified Dutch auction on the client in substantially real time.

12. The system of claim 11 wherein the software script is adapted to display a graphical representation of the modified Dutch auction as the modified Dutch auction progresses.

13. The system of claim 12 wherein the graphical representation of the progress of the modified Dutch auction comprises a marker configured to move along a scale displaying discount savings from 0% to 100% savings, wherein the marker's position along the scale corresponds to a current discount active in the modified Dutch auction.

14. The system of claim 13 wherein the software script includes instructions to be executed by the client for calculating the current discount based on initial conditions of the modified Dutch auction and an internal clock associated with the client.

15. The system of claim 10 wherein the interface page is adapted to display a current discount value that grows over time as the modified Dutch auction progresses.

16. The system of claim 10 wherein the auction interface page includes a selectable input allowing a user to access an order entry page for purchasing an item during the modified Dutch auction.

17. The system of claim 10 further comprising order entry means for entering orders on a retailer's order entry system in response to a user purchasing a product during the modified Dutch auction.

18. The system of claim 10 wherein the auction interface page includes a chat feature allowing a user to post comments regarding the modified Dutch auction and read comments posted by other participants in the modified Dutch auction.

19. A computer readable storage medium containing software instructions executable by a computer, the software instructions configured to cause the computer to perform the steps of:
displaying a current discount associated with a modified Dutch auction; and
providing a selectable input allowing a user to place an order for a product being sold in the modified Dutch auction at a price determined by the current discount.

20. The computer readable storage medium of claim 19 wherein the current discount is calculated based on a discount rate and a length of time that the modified Dutch auction has been in progress.

21. The computer readable storage medium of claim 19 wherein displaying the current discount associated with the modified Dutch auction comprises displaying a real-time ticker including a current discount scale extending from a first discount value to a second discount value, and a sliding window that moves along the current discount scale between the first discount value and the second discount value during the modified Dutch auction, and displays a current discount value corresponding to the sliding window's position along the current discount scale.

22. The computer readable storage medium of claim 21 wherein the software instructions are further configured to cause the computer to calculate a discount rate based on the first discount value, the second discount value, a modified Dutch auction start time, and a modified Dutch auction end time.

23. The computer readable storage medium of claim 21 wherein the software instructions are further configured to calculate an auction elapsed time based on the modified Dutch auction start time, and a current time determined by an internal clock associated with the computer, and wherein calculating the current discount comprises multiplying the elapsed time by the discount rate.

24. The computer medium of claim 23 wherein the software instructions are further configured to synchronize the passage of time as determined by the internal clock associated with the computer and an internal clock associated with a second computer.

25. The computer readable medium of claim 19 wherein the software instructions are further configured to cause the computer to display messages from remote participants in the modified Dutch auction.

26. The computer readable medium of claim 19 wherein the software instructions are further configured to receive input messages from a first modified Dutch auction participant to be transmitted to and displayed for a second modified Dutch auction participant.
